(19) United States
(12) Patent Application Publication
(10) Pub. No.: US 2017/0052545 A1
(43) Pub. Date: Feb. 23, 2017

(54) GAS MONITORING AND ENERGY RECYCLING SYSTEM

(71) Applicant: Robert Cortez, Denver, CO (US)

(72) Inventor: Robert Cortez, Denver, CO (US)

(21) Appl. No.: 14/829,973

(22) Filed: Aug. 19, 2015

(51) Int. Cl. G05D 7/06; G05D 23/19; G05B 15/02

(52) U.S. Cl. CPC G05D 7/06; G05B 15/02; G05D 23/193

(57) ABSTRACT

A gas monitoring and energy recycling system is described. Embodiments of the system can include a central control module, an energy recycling system, and a gas monitoring system including an HVAC monitoring subsystem, a natural gas monitoring subsystem, and a carbon monoxide monitoring subsystem. Typically, the central control module can be implemented to monitor, receive, and store data from the gas monitoring system and subsystems and the energy recycling system. In one embodiment, the central control module can be adapted to activate and/or deactivate one or more components of the gas monitoring system and the energy recycling system based on signals received from the two systems.

### BACKGROUND

Heat, ventilation, and air conditioning systems are well known. Typically, HVAC systems will include a thermostat to control a temperature inside a home. Usually, the thermostat will include a thermometer to determine a current temperature inside the home proximate the thermostat. However, these HVAC systems are limited since they depend on a local temperature to control an entire home. Many times, a location of the thermostat will be a few degrees cooler or higher than the rest of the house. As such, the HVAC system will run the furnace or air conditioner when not needed.

Untold numbers of people accidently die every year from car exhaust in garages. Currently, there is no means for combating accidental deaths related to carbon monoxide poisoning inside garages.

Every day, energy is wasted as exhaust from restaurants and homes. Generally, homes and restaurants will exhaust air heated from a cook top to the outside. This heated air is dispersed into the outside air and the energy used to create it is lost. Money and energy could be saved by recycling some of the energy used to make the heated air.

There currently is a need for a system to smartly monitor an HVAC system, provide safety measures when there is carbon monoxide buildup in a garage, and a system to recycle energy used to cook.

### BRIEF DESCRIPTION OF THE DRAWINGS

FIG. 1A is a block diagram of a gas monitoring and energy recycling system according to one embodiment of the present invention.

FIG. 1B is a block diagram of a gas monitoring and energy recycling system according to one embodiment of the present invention.

FIG. 2A is a block diagram of an HVAC monitoring subsystem according to one embodiment of the present invention.

FIG. 2B is a block diagram of a remote module according to one embodiment of the present invention.

FIG. 3 is a block diagram of a natural gas monitoring subsystem according to one embodiment of the present invention.

FIG. 4 is a block diagram of a carbon monoxide monitoring subsystem according to one embodiment of the present invention.

FIG. 5A is a block diagram of an energy recycling system according to one embodiment of the present invention.

FIG. 5B is a block diagram of an energy recycling system according to one embodiment of the present invention.

### DETAILED DESCRIPTION

Embodiments of the present invention include a gas monitoring and energy recycling system. Typically, the system can include, but is not limited to, a central control module, a gas monitoring system, and an energy recycling system. Typically, the central control module can be connected to both the gas monitoring system and the energy recycling system. In one embodiment, the gas monitoring system can be used in conjunction with the energy recycling system. In another embodiment, the gas monitoring system and the energy recycling system can be implemented as independent systems.

The central control module can be adapted to receive information from the gas monitoring system and the energy recycling system and provide information to various outlets. For instance, the central control module may include a user interface from which a homeowner can view information from the central control module. In another instance, the central control module can generate an alert to send information to one or more emergency response teams via phone, text, or email. Generally, depending on information received from either system, the central control module can activate or deactivate one or more components of the two systems and provide information to a homeowner or emergency response team.

The gas monitoring system can generally include, but is not limited to, an HVAC monitoring subsystem, a natural gas monitoring subsystem, and a carbon monoxide monitoring subsystem. The gas monitoring system can be connected to the previously mentioned central control module for monitoring of the three subsystems. In some embodiments, the gas monitoring system can include one or more of the subsystems. For instance, in a home application, the gas monitoring system can include the HVAC monitoring subsystem and the carbon monoxide monitoring subsystem. In another instance, in a business building application, the gas monitoring system can include the HVAC monitoring subsystem and the natural gas monitoring subsystem. It is to be appreciated that more or less of the subsystems can be included depending on particular situations.

The HVAC monitoring subsystem can include, but is not limited to, a plurality of remote modules having a plurality of sensors and an external damper with a temperature probe. The remote modules can include the plurality of sensors to monitor various conditions inside a home. The outside damper can be implemented to provide fresh air to a home. Typically, the natural gas monitoring subsystem can include, but is not limited to, the plurality of remote modules having the plurality of sensors and a gas supply line shutoff valve. In one embodiment, the natural gas monitoring subsystem can include a communications function, an alarm activation function, and a ventilation shutoff function. In a typical implementation, the natural gas monitoring subsystem can be implemented to monitor and, if needed, shut off a natural gas supply line via the shutoff valve. The carbon monoxide monitoring subsystem can generally be located in a garage or similar structure and can include, but is not limited to, a carbon monoxide sensor, an alarm function, a vehicle shutoff function, and garage door opening function.

The energy recycling system can typically be integrated into a cooking range or cook top for recycling heat generated by the cooking range. The energy recycling system can include, but is not limited to, a kitchen hood having conduits for transferring heat, an exhaust for moving heat away from the kitchen hood to an air handling unit or outdoors, and a fire extinguishing function.

In one embodiment, each of the components of the gas monitoring system and each component of the energy recycling system can be connected to the central control module. Typically, the central control module can include, but is not limited to, a processor, a user interface, random access memory, storage, and a network interface. In one embodiment, each of the components of the two systems can be wirelessly connected to the central control module. Typically, the central control module can include an application or program adapted to control the gas monitoring system and the energy recycling system. In some instances, the central control module can be implemented with smart systems already controlling HVAC components. For instance, the central control module can be adapted to work with or replace an existing thermostat.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), an erasable programmable read-only memory (EPROM or Flash memory), an optical fiber, a portable compact disc read only memory (CD-ROM), and a digital video disk read only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, of otherwise professed in a suitable manner, if necessary, and then stored in a computer memory.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

### An Embodiment of a Gas Monitoring and Energy Recycling System

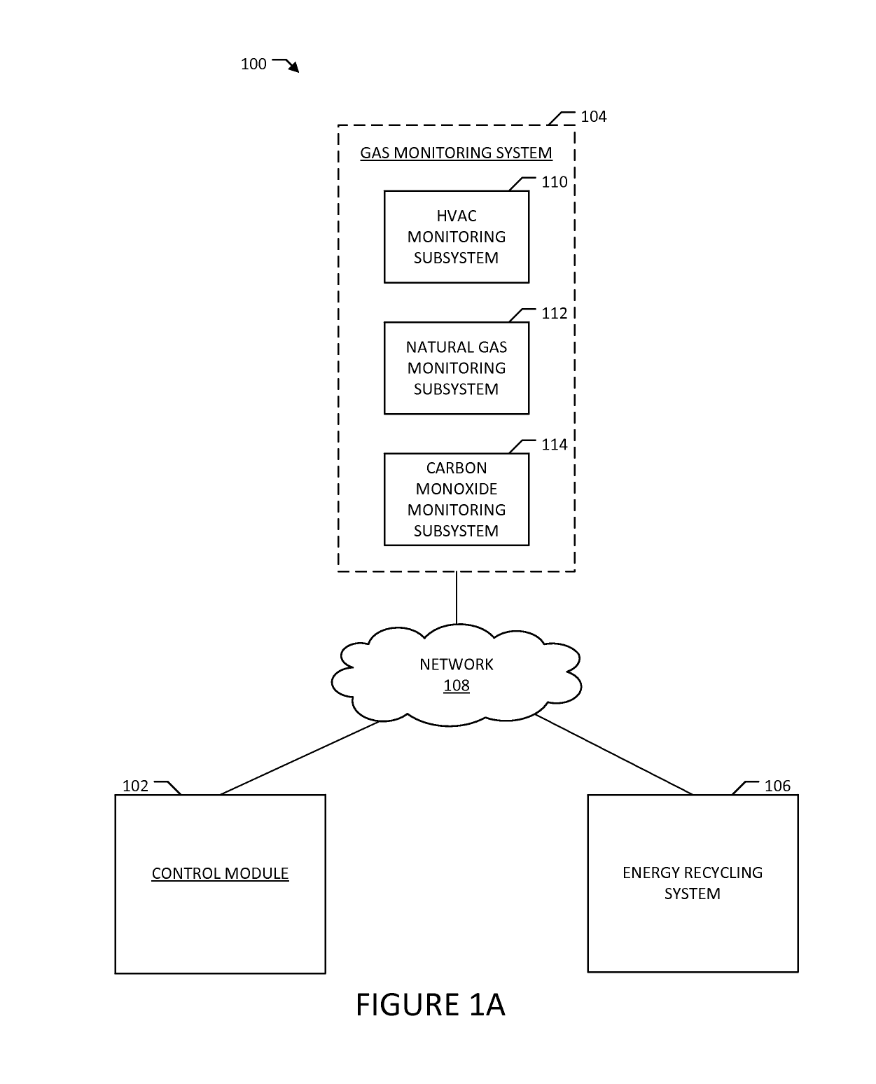

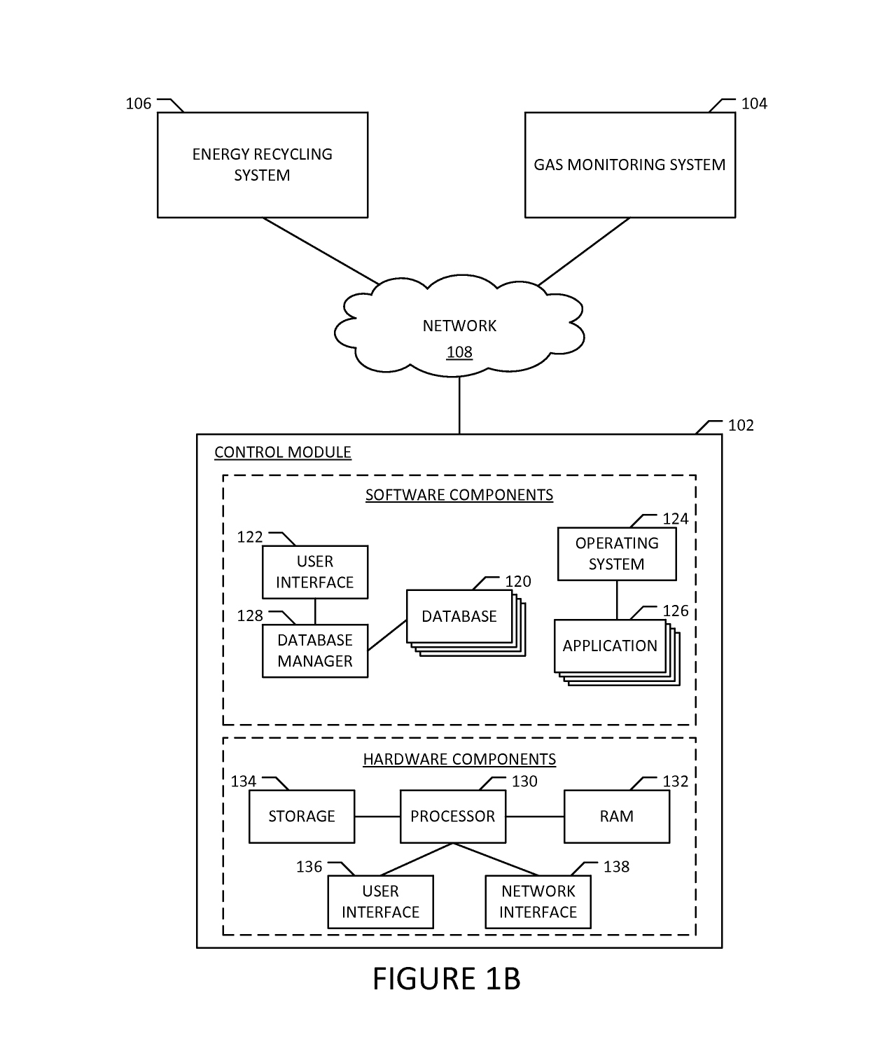

Referring to FIG. 1A, a block diagram of an embodiment 100 showing a gas monitoring and energy recycling system is illustrated. The system 100 can be implemented to monitor natural gas, monitor air quality in a home, provide carbon monoxide monitoring in a garage, and recycle heat energy from a cooktop.

As shown in FIG. 1A, the gas monitoring and energy recycling system can include, but is not limited to, a control module 102, a gas monitoring system 104, and an energy recycling system 106. A network 108 can be implemented to connect each of the systems together. For instance, a wireless network can be implemented. Hereinafter, the control module 102 of the gas monitoring and energy recycling system 100 will be referred to as the central control module 102.

In one embodiment, the gas monitoring system 104 can include one or more subsystems that combine to make the gas monitoring system 104. The gas monitoring system 104 can include, but is not limited to, an HVAC monitoring subsystem 110, a natural gas monitoring subsystem 112, and a carbon monoxide monitoring subsystem 114.

In one embodiment, the central control module 102 can be implemented to monitor and interface with each system and subsystem of the gas monitoring and energy recycling system 100.

Generally, an operating system can be stored in the central control module 102. The operating system can be implemented to control the gas monitoring system 104 and interact with the energy recycling system 106 and the one or more subsystems 110-114.

Referring to FIG. 1B, a block diagram of the the gas monitoring and energy recycling system 100 including a detailed block diagram of the central control module 102 is illustrated. The central control module 102 can represent a server or another powerful, dedicated computer system that can support multiple user sessions. In some embodiments, the central control module 102 can be any type of computing device including, but not limited to, a personal computer, a game console, a smartphone, a tablet, a netbook computer, or other computing devices. In one embodiment, the central control module 102 can be a distributed system wherein server functions are distributed over several computers connected to a network. The central control module 102 can have a hardware platform and software components.

The software components of the central control module 102 can include one or more databases 120 which can store data, information, and instructions. The software components can also include a user interface 122 and an operating system 124 on which various applications 126 can execute. It is to be appreciated that the user interface 122 can include a graphical representation of the operating system and various applications. A database manager 128 can be an application that runs queries against the databases 120. In one embodiment, the database manager 128 can allow interaction with the databases 120 through an HTML user interface on a user device. For instance, a home owner may interact with the central control module 102 via a smart phone or tablet.

The hardware platform of the central control module 102 can include, but is not limited to, a processor 130, random access memory 132, and nonvolatile storage 134. The processor 130 can be a single microprocessor, multi-core processor, or a group of processors. The random access memory 132 can store executable code as well as data that can be immediately accessible to the processor. The nonvolatile storage 134 can store executable code and data in a persistent state.

The hardware platform can include a user interface 136. The user interface 136 can include keyboards, monitors, pointing devices, and other user interface components. The hardware platform can also include a network interface 138. The network interface 138 can include, but is not limited to, hardwired and wireless interfaces through which the central control module 102 can communicate with the gas monitoring system 104, the energy recycling system 106, and the subsystems 110-114.

The network 108 can be any type of network, such as a local area network, wide area network, or the Internet. In some cases, the network 108 can include wired or wireless connections and may transmit and receive information using various protocols.

In a typical implementation, the central control module 102 can be adapted to receive information and data from the gas monitoring system 104 and the energy recycling system 106. In some instances, the central control module 102 can be adapted to activate and/or deactivate various components of the systems 104, 106 based on data or signals received from the systems 104, 106. For instance, the central control module 102 can open or close a damper of the HVAC monitoring subsystem 110 based on signal received from the HVAC monitoring subsystem 110.

### An Embodiment of an HVAC Monitoring Subsystem

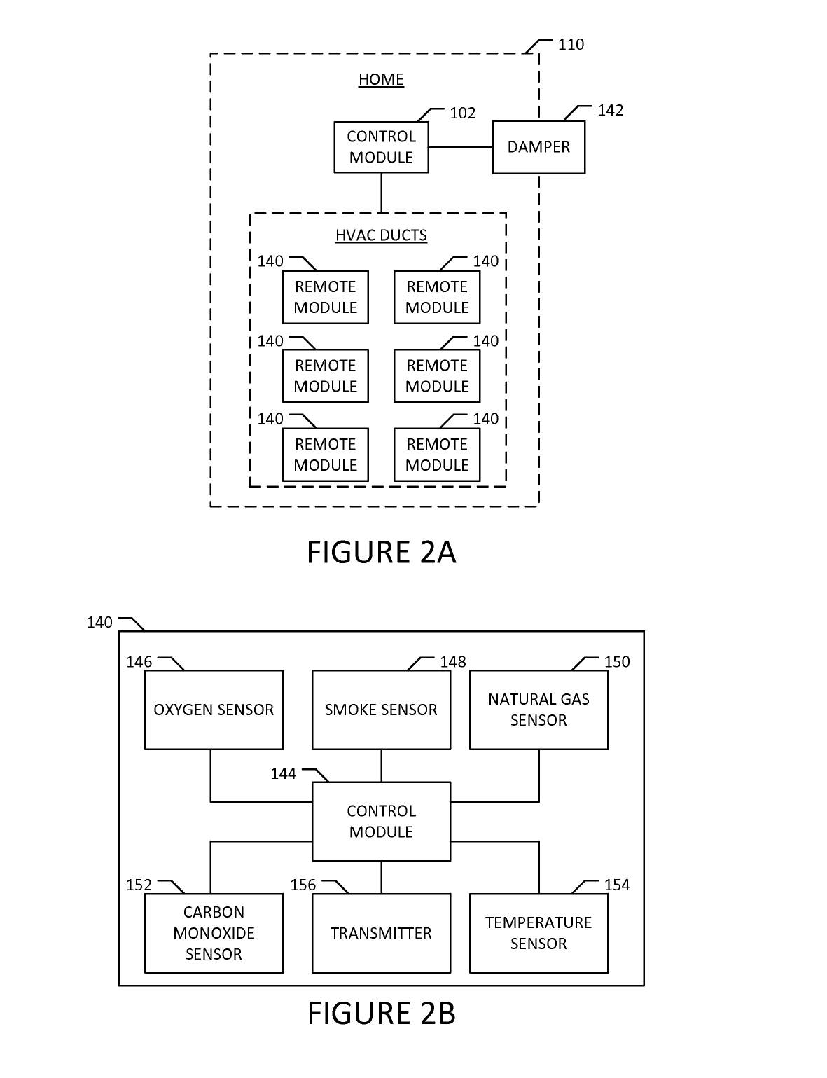

Referring to FIG. 2A, a block diagram of an embodiment of the heating, ventilation, and air conditioning (HVAC) monitoring subsystem 110 is illustrated. Typically, the HVAC monitoring subsystem 110 can be implemented to monitor an HVAC system in a home or building.

In one embodiment, the HVAC monitoring subsystem 110 can include, but is not limited to, a plurality of remote modules 140 and a damper 142. Generally, the remote modules 140 can be located throughout a duct network of the a HVAC system in a home. The damper 142 can generally be located on an exterior of a home. Each of the remote modules 140 and the damper 142 can be connected to the central control module 102. The central control module 102 can be implemented to receive data, information, and signals from each of the remote modules 140. For instance, the central control module 102 can receive temperature measurements from each of the remote modules 140. Based on the temperature measurements, the central control module 102 can be turn a furnace or air conditioner on to heat or cool a particular section of a home. Typically, the central control module 102 can be adapted to open and close the HVAC monitoring damper 142 based on various signals received from the remote modules 140. It is to be appreciated that the damper 142 can be implemented to allow outside air into a building or home.

Referring to FIG. 2B, a block diagram of a remote module 140 is illustrated. As shown, each of the remote modules 140 can include, but are not limited to, a control module 144, an oxygen sensor 146, a smoke sensor 148, a natural gas sensor 150, a carbon monoxide sensor 152, a temperature sensor 154, and a transmitter 156. Hereinafter, the control module 144 of the remote modules 140 will be referred to as the remote control module 144. Generally, the remote control module 144 can be implemented to monitor, receive, and generate signals from each of the sensors.

In one embodiment, the HVAC monitoring subsystem 110 can monitor air quality and oxygen levels inside a home. Typically, the one or more sensors in the remote modules 140 can be used to monitor various air quality metrics. It is to be appreciated that the sensors can be implemented to indirectly control the damper 142. In one embodiment, the HVAC monitoring subsystem 110 can include an outdoor temperature probe to determine if outside air can be used to cool the home.

Typically, the oxygen sensors 146 can be implemented to measure an oxygen content in air flowing through a home and the HVAC system. Depending on the oxygen levels measured and recorded, the central control module 102 can be adapted to open and close the damper 142 to provide fresh air into a home or the HVAC system. Typically, the central control module 102 can open and close the damper 142 based on a predetermined threshold for oxygen levels, and once that threshold is measured by one of the remote modules 140, the central control module 102 can open the damper 142.

In one instance, the remote modules 140 can monitor an oxygen count and/or indoor air quality. When the control modules 102 determines that the air inside a home is considered poor, the central control module 102 can open the damper 142 to allow more oxygen concentrated air to come in to the home. Once the central control module 102 receives a signal that the oxygen levels are satisfactory, the central control module 102 can close the damper 142. By implementing the oxygen sensors 146, better living conditions can be achieved while the HVAC monitoring subsystem 110 can be adapted to exhaust contaminated air via the damper 142.

The smoke sensors 148 can be implemented to detect smoke. In addition to smoke detectors located in a home, the smoke sensors 148 can provide additional smoke detection and alert the central control module 102 if smoke is detected. If smoke is detected, the remote control module 144 can send a signal to the central control module 102 to sound an alarm and alert a fire department. The remote modules 140 can also send a signal indicating which of the remote modules 140 is sending the smoke alert signal to let the central control module 102 know where the smoke was detected. This information can be passed on to a homeowner and/or the fire department.

The natural gas sensors 150 can be implemented to detect natural gasses commonly used in homes. Similar to the smoke sensors 148, the natural gas sensors 150 can be used to detect natural gas leaks in a home and alert a homeowner via the central control module 102 that the home has a gas leak.

The carbon monoxide sensors 152 can be implemented to detect elevated levels of carbon monoxide. Similar to the smoke sensors 148, the carbon monoxide sensors 152 can provide additional carbon monoxide detection to carbon monoxide detectors already present in a home. Since the remote modules 140 are located throughout a home, when a carbon monoxide sensor 152 detects elevated levels of carbon monoxide, a location of the sensor that detected the elevated levels can be sent to the central control module 102. As such, a homeowner can have a general idea of where the carbon monoxide is coming from. In one embodiment, the central control module 102 can send information to an emergency response team indicating a location of the carbon monoxide sensor that detected the elevated carbon monoxide levels in response to receiving an elevated carbon monoxide level signal from one of the remote modules 140.

In one embodiment, the temperature sensors 154 of the remote modules 140 can be implemented to provide a plurality of temperature monitoring zones. For instance, a temperature in each of the zones can be individually monitored by the temperature sensors 154 in each of the remote modules 140. By implementing the temperature sensors 154, the HVAC monitoring subsystem 110 can provide energy savings since the HVAC system will only heat or cool as needed based on the temperature measurements.

### An Embodiment of a Natural Gas Monitoring Subsystem

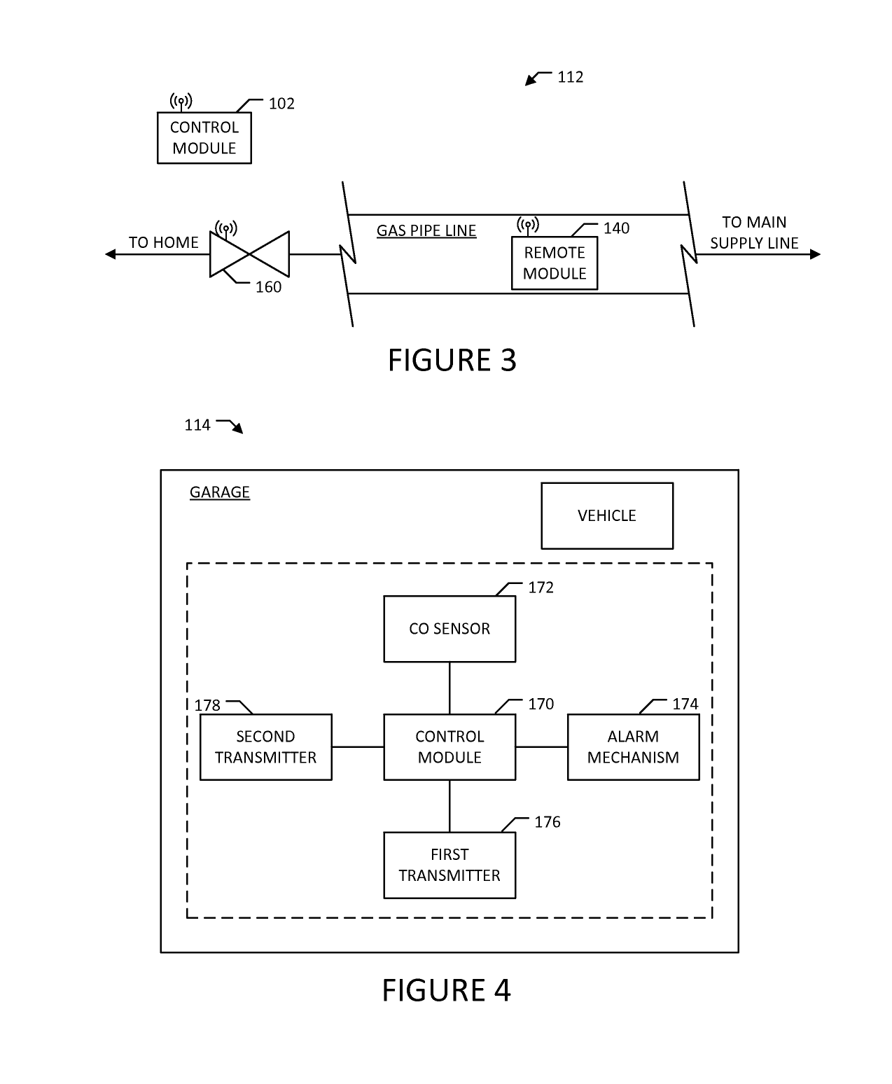

Referring to FIG. 3, a block diagram of an embodiment of the natural gas monitoring subsystem 112 is illustrated. Typically, the natural gas monitoring subsystem 112 can be implemented to monitor a natural gas supply line or lines into a home or building. The natural gas monitoring system 112 can be adapted to turn off a gas supply to a home when detecting that there is a leak in a gas pipe or in the home.

As shown in FIG. 3, the natural gas monitoring subsystem 112 can typically be implemented with the one or more remote modules 140 of the HVAC monitoring subsystem 110. The natural gas monitoring subsystem 112 can include, but is not limited to, the one or more remote modules 140, an automated shutoff valve 160, and the central control module 102. Typically, the automated shutoff valve 160 can be located at a main gas supply line entering a home. As shown, each of the components can include a wireless network interface for transmitting and receiving signals from other components.

As mentioned previously, the natural gas sensors 150 can be implemented to detect elevated levels of natural gas. In instances implementing the natural gas monitoring subsystem 112, the central control module 102 can be adapted to turn the automated shutoff valve 160 to an off position when elevated natural gas levels are detected by the natural gas sensors 150. For instance, a natural gas sensor 150 may detect elevated levels of natural gas. The control module 142 of the remote module 140 can be adapted to send a signal indicating there is a gas leak to the central control module 102 in response to the elevated natural gas levels. The central control module 102 can then send a signal to the automated shutoff valve 160 to close or shutoff the natural gas supply line to the home.

In one embodiment, a remote module 140 can be located in a natural gas line leading to the home. The remote modules 140 located in the natural gas lines can be connected to the central control module 102. Typically, at least one remote module 140 can be located inside a main gas line entering a home. In some embodiments, the remote module 140 located outside the home can include fewer components. For instance, the remote module 140 located in the natural gas line can include a natural gas sensor, a control module, and a transmitter. The control module can be adapted to send a signal via the transmitter to the central control module 102 indicating that there is a natural gas leak in the line based on the natural gas sensor detecting elevated levels of natural gas.

Typically, the central control module 102 can turn the gas supply back on when an emergency response team has cleared the home and indicated it is safe to return to. For instance, the central control module 102 can include a special password in the signal sent to the emergency response team. The central control module 102 can require the special password before opening the automated shutoff valve 160 and returning natural gas back to the home. Alternatively, a natural gas supplier can have a special password for the central control module 102 to reestablish service to the home.

### An Embodiment of a Carbon Monoxide Monitoring Subsystem

Referring to FIG. 4, a block diagram of an embodiment of the carbon monoxide (CO) monitoring subsystem 114 is illustrated. Typically, the carbon monoxide monitoring subsystem 114 can be located inside a garage. It is to be appreciated that the CO monitoring subsystem 114 can be located in locations other than a garage where carbon monoxide may be found.

In one embodiment, the CO monitoring subsystem 114 can be remotely connected to the central control module 102 of the gas monitoring and energy recycling system 100, as shown in FIG. 1.

The CO monitoring subsystem 114 can typically include, but is not limited to, a control module 170, a carbon monoxide (CO) sensor 172, an alarm mechanism 174, a first transmitter 176, and a second transmitter 178. As shown, the control module 170 can be connected to the carbon monoxide sensor 172, the alarm mechanism 174, the first transmitter 176, and the second transmitter 178. In one embodiment, the CO monitoring system 114 components can be wirelessly connected to the CO monitoring control module 170.

Typically, the CO monitoring control module 170 can include components similar to the central control module 102. For instance, the CO monitoring control module 170 can include hardware components and software components. In one example, the hardware components can include, but are not limited to, a processor, storage, random access memory, and a network interface. Typically, the CO monitoring control module 170 can be adapted to activate the alarm mechanism 174, the first transmitter 176, and the second transmitter 178 based on a signal received from the CO sensor 172.

In one embodiment, the carbon monoxide sensor 172 can be an electrochemical sensor. It is to be appreciated that other types of carbon monoxide sensors can be implemented without exceeding a scope of the present invention. The first transmitter 176 can be adapted to send a signal to a garage door opener to open a garage door. For instance, the first transmitter 176 can transmit a radio signal at a particular frequency recognized by the garage door opener. The second transmitter 178 can be adapted to send a signal to an electronics control unit of a vehicle to turn an engine of the vehicle off.

In a typical implementation, the CO monitoring subsystem 114 can be implemented as a safety measure in a residential garage. Typically, the CO monitoring subsystem 114 can be used to sound an alarm and open a garage door in instances where a vehicle has been left running inside the garage with the garage door down.

In one example, when the CO sensor 172 detects carbon monoxide at a dangerous level, the CO monitoring control module 170 can be adapted to first activate the alarm mechanism 174 for approximately 15 seconds. After the alarm mechanism 174 has been activated, the CO monitoring control module 170 can activate the second transmitter 178 to turn the vehicle off After the vehicle has been turned off and the alarm mechanism has been activated for approximately 30 seconds, the CO monitoring control module 170 can activate the first transmitter 176 to open the garage door. In some instances, the control module 170 can be adapted to notify an emergency response team along with a home owner by a text or a phone call. For instance, the CO monitoring control module 170 can send a prerecorded message to the emergency response team.

In one embodiment, the CO monitoring control module 170 can be adapted to send a signal to the central control module 102. The central control module 102 can then send an alert to the emergency response team in response to receiving the signal from the CO monitoring control module 170.

### An Embodiment of an Energy Recycling System

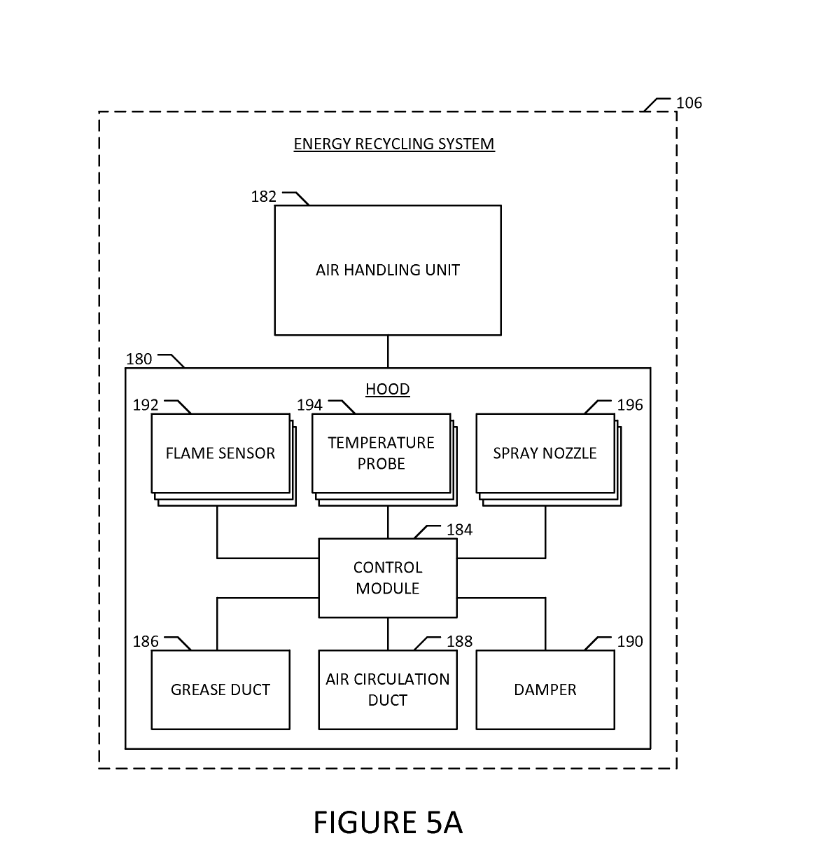

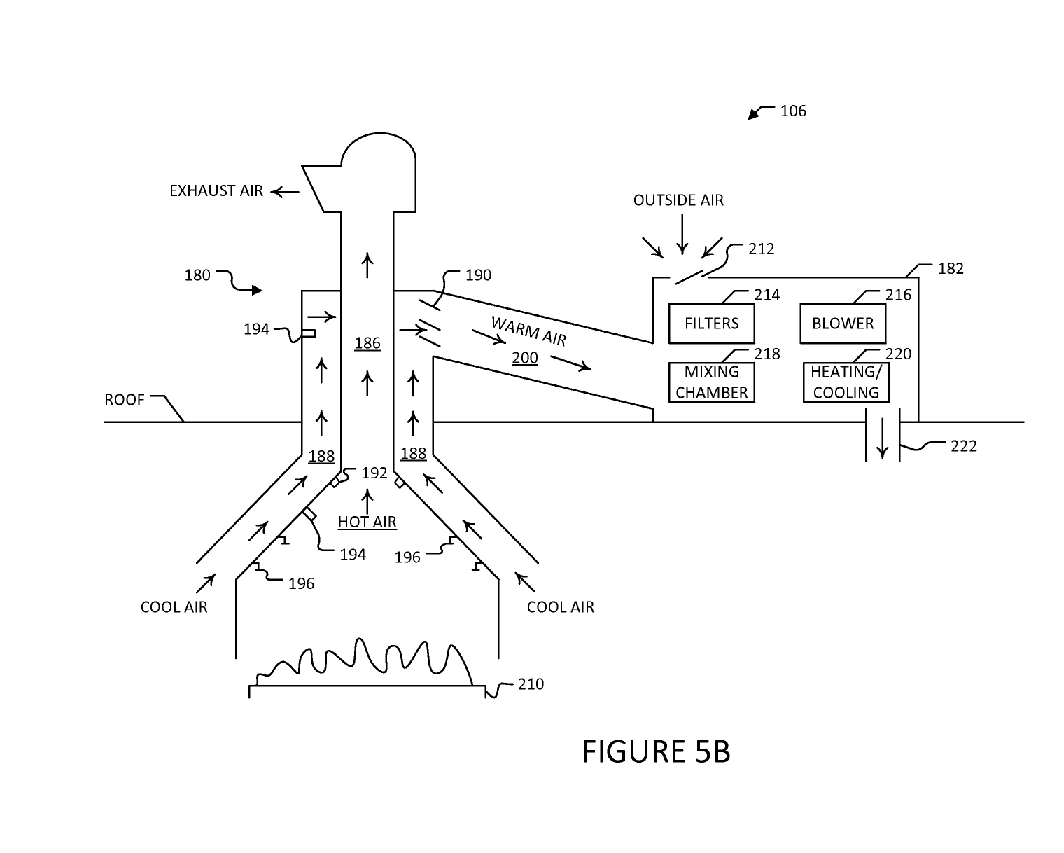

Referring to FIG. 5A, a block diagram of an embodiment of the energy recycling system 106 is illustrated. Typically, the energy recycling system 106 can be implemented in the previously mentioned gas monitoring and energy recycling system 100. In some embodiments, the energy recycling system 106 can be implemented as a standalone system.

As shown in FIG. 5A, the energy recycling system 106 can typically include a hood 180 and an air handling unit 182. In some embodiments, the hood 180 can be implemented with a previously existing air handling unit.

Typically, the hood 180 can include, but is not limited to, a control module 184, a grease duct 186, an air circulation duct 188, a damper 190, one or more flame sensors (or detectors) 192, one or more temperature probes 194, and one or more spray nozzles 196. As shown, each of the components of the hood 180 can be integrated into a design of the hood 180. Generally, each of the components can be wirelessly connected to the control module 184.

The control module 184 can generally include substantially similar components to the previously disclosed central control module 102. For instance, the energy recycling control module 184 can include software components and hardware components. Typically, each of the components can be controlled by the control module 184. For instance, the control module 184 can determine when the damper 190 is opened and closed. In another instance, based on a measurement from one of the flame sensors 192, the control module 184 can activate a shut-off sequence or activate the spray nozzles 196.

Referring to FIG. 5B, a detailed diagram of one embodiment of the energy recycling system 106 is illustrated. As shown, in a typical implementation, the hood 180 can be connected to the air handling unit 182. For instance, a duct 200 can be implemented to connect the hood 180 to the air handling unit 182. The damper 190 can dictate how much air is directed to the air handling unit 182. As previously mentioned, the damper 190 can be controlled by the control module 184. Typically, the damper 190 can be opened when the control module 184 determines that warm air is needed for the air handling unit 182. In one instance, the control module 184 can determine when to open the damper 190 based on energy consumption by a cooktop. For example, the control module 184 can monitor energy consumption in British thermal units (BTUs) and open the damper 190 when a threshold BTU is reached. It is to be appreciated that the BTU threshold will need to be determined on a system by system basis.

In one embodiment, the hood 180 can include the one or more flame sensors 192 and the one or more spray nozzles 196 as part of a fire suppression system. Typically, the flame sensors 192 and the spray nozzles 196 can be wirelessly connected to the control module 184. In one instance, the control module 184 can activate the spray nozzles 196 based on information, data, or a signal received from the flame sensors 192. For example, the flame sensors 192 can be adapted to send a signal to the control module 184 when the sensor detects flames from a grease fire. In one embodiment, the flame sensors 192 can be ultraviolet/infra-red detectors.

In a typical implementation, the energy recycling system 106 can recycle energy from a cooktop. As shown in FIG. 5B, the hood 180 can be placed proximate a cooktop 210. When the cooktop 210 is being used, heated air can be funneled through the grease duct 186. Typically, the grease duct 186 can be fluidly connected to an exhaust located outside a building the hood 180 is located in. As shown, the hood 180 can include an air circulation duct 188 that surrounds the grease duct 186. The air circulation duct 188 can be adapted to have room temperature air flow through the air circulation duct 188 and interface with the grease duct 186. Generally, some of the heat from the heated air can be transferred to the air inside the air circulation duct 188. The air circulation duct 188 can exit to the duct 200 via the damper 190. As such, heat from the cooktop can be transferred to air routed to return to the air handling unit 182. Typically, the control module 184 can automate when to open the damper 190 to allow the heated air to return to the air handling unit 182.

The air handling unit 182 can typically include, but is not limited to, a damper 212, one or more filters 214, a blower or fan 216, a mixing chamber 218, heating/cooling components 220, and an exhaust duct 222. The damper 212 can be implemented to bring in outside air to the air handling unit 182. In one embodiment, the control module 184 can be adapted to control an opening and closing of the air handling unit damper 212. For instance, the damper 212 can remain closed when the hood 180 is providing sufficient warm air to keep a room warm. The blower 216 can be implemented to draw in air from outside and then move air from the air handling unit 182 into a room where the hood 180 is located. The mixing chamber 218 can be implemented to mix the recycled warm air with air brought in through the damper 212. Depending on an outside and inside temperature, the heating/cooling components 220 can be implemented to heat or cool air coming from the air handling unit 182. The exhaust duct 222 can be implemented as a conduit for the air from the air handling unit 182 to a particular room or rooms.

In an alternative embodiment, the air circulation duct 188 can be retrofitted to have a liquid pass through the duct. For instance, the liquid can be a glycol solution or similar solution that is efficient in absorbing heat. In another instance, the liquid can be water. The liquid can then be returned to a heat exchanger to store the heat for later use.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A system for use in a home, the system comprising:
a central control module having a processor, a user interface, a network interface, and a memory;
an energy recycling subsystem connected to the central control module, the energy recycling subsystem including a cooktop hood and an air handling unit;
wherein the cooktop hood includes (i) a first control module, (ii) a grease duct, (iii) an air circulation duct, (iv) a first damper, (v) one or more flame sensors, (vi) one or more temperature probes, and (vii) one or more spray nozzles;
a gas monitoring subsystem, the gas monitoring subsystem including one or more remote modules and a second damper connected to the central control module;
wherein each of the one or more remote modules include (i) a carbon monoxide sensor, (ii) a smoke sensor, (iii) an oxygen sensor, (iv) a natural gas sensor, (v) a second control module, and (vi) a transmitter;
a carbon monoxide monitoring subsystem adapted to be located in a garage of the home and connected to the central control module, the carbon monoxide subsystem including (i) a third control module, (ii) an alarm mechanism, (iii) a first transmitter, (iv) a second transmitter, and (v) a carbon monoxide sensor.

2. The system of claim 1, wherein the central control module is adapted to receive and store data from each of the remote modules.

3. The system of claim 1, wherein each of the remote modules sends a signal to the central control module including oxygen levels, carbon monoxide levels, and natural gas levels.

4. The system of claim 3, wherein the central control module sounds an alarm when one of the carbon monoxide levels or natural gas levels is above a predetermined threshold limit.

5. The system of claim 3, wherein the central control module is adapted to sound an alarm when one of the smoke sensors of the one or more remote modules detect smoke.

6. The system of claim 3, wherein the central control module is adapted to open the second damper when the oxygen levels fall below a predetermined threshold.

7. The system of claim 1, wherein the third control module is adapted to initiate the alarm mechanism when the carbon monoxide sensor detects an elevated level of carbon monoxide.

8. The system of claim 7, wherein the third control module is adapted to activate the first transmitter when the carbon monoxide sensor detects an elevated level of carbon monoxide, the first transmitter adapted to send a signal to a garage door opener.

9. The system of claim 8, wherein the third control module is adapted to activate the second transmitter when the carbon monoxide sensor detects an elevated level of carbon monoxide, the second transmitter adapted to send a signal to an electronics control unit of a vehicle to turn an engine of the vehicle off.

10. The system of claim 7, wherein the third control module sends the elevated carbon monoxide levels to the central control module.

11. The system of claim 10, wherein the central control module sends an alert to an emergency response team in response to receiving the elevated carbon monoxide levels.

12. The system of claim 1, wherein heat is transferred from air in the grease duct to air in the air circulation duct.

13. The system of claim 12, wherein air from the air circulation duct is transferred to the air handling unit.

14. The system of claim 13, wherein the first control module determines when air from the air circulation duct is transferred to the air handling unit.

15. The system of claim 14, wherein the first control module is adapted to open and close the first damper to transfer air from the air circulation duct to the air handling unit.

16. A system for use in a home, the system comprising:
a central control module adapted to receive and store data;
an energy recycling subsystem connected to the central control module, the energy recycling subsystem adapted to capture energy from an exhaust of a cook top and return the energy to an air handling unit;
a gas monitoring subsystem connected to the central control module, the gas monitoring subsystem adapted to (i) monitor oxygen levels, natural gas levels, and carbon monoxide levels, and (ii) detect smoke; and
a carbon monoxide monitoring subsystem located in a garage of the home and connected to the central control module, the carbon monoxide monitoring subsystem adapted to monitor the garage for elevated levels of carbon monoxide;
wherein the central control module is adapted to activate or deactivate one or more components of each of the subsystems in response to receiving data from the one or more subsystems.

17. The system of claim 16, wherein the energy recycling subsystem includes:
an air handling unit; and
a cook top hood, the cook top hood having:
a control module;
a grease duct;
an air circulation duct;
a damper;
one or more flame sensors;
one or more temperature probes; and
one or more spray nozzles.

18. The system of claim 16, wherein the gas monitoring subsystem includes:
a damper; and
one or more remote modules, the one or more remote modules each including:
a carbon monoxide sensor;
a smoke sensor;
an oxygen sensor;
a natural gas sensor;
a control module; and
a transmitter.

19. The system of claim 16, wherein the carbon monoxide monitoring subsystem includes:
a control module;
an alarm mechanism;
a first transmitter;
a second transmitter; and
a carbon monoxide sensor.

20. A system located in a home, the system comprising:
a central control module;
an energy recycling subsystem connected to the central control module;
a gas monitoring subsystem connected to the central control module; and
a carbon monoxide monitoring subsystem located in a garage of the home and connected to the central control module;
wherein the central control module is adapted to activate or deactivate one or more components of each of the subsystems in response to receiving data from the one or more subsystems.
